(19) United States
(12) Patent Application Publication
(10) Pub. No.: US 2005/0144140 A1
(43) Pub. Date: Jun. 30, 2005

(54) Information processing system, information processing method, and information processing apparatus

(75) Inventor: Yutaka Nagao, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SONY CORPORATION, Tokyo (JP)

(21) Appl. No.: 10/965,846

(22) Filed: Oct. 18, 2004

(30) Foreign Application Priority Data
Nov. 5, 2003 (JP) 2003-376113

(51) Int. Cl. G06F 17/60

(52) U.S. Cl. 705/59

(57) ABSTRACT

A client transmits existing license information that includes usage conditions of content, additional difference information including an additional usage condition, and a client certificate to a license server. The license server updates the existing license information based on the additional difference information to generate updated license information, and returns the updated license information to the client.

### BACKGROUND OF THE INVENTION

1. Field of the Invention

The present invention relates to an information processing apparatus and method for issuing a license to a communication terminal that is allowed to use content under usage conditions defined in license information given by a copyright owner. The present invention further relates to an information processing system including the information processing apparatus and the communication terminal, and to an information processing method.

2. Description of the Related Art

Commercial services for purchasing digital content, such as music and video, over a network, such as the Internet, have become widely available. For example, with electronic music distribution (EMD) services over the Internet, users can download digital music content and can store it in a client terminal or a personal computer to enjoy the content on the personal computer.

The personal computer initiates a music recording and playback application including a certain copyright protection technology under an operating system (OS), and stores a content file including encrypted digital content and a rights file including usage conditions for the digital content in a storage device, such as a hard disc drive (HDD), thus realizing a highly secure service.

Japanese Unexamined Patent Application Publication No. 14-359616 discloses an information processing apparatus in which a music recording and playback application including a certain copyright protection technology prevents content from being illegally used without impeding distribution of the content.

Typically, a user obtains a license that defines usage conditions, such as the number of times the content can be used, and uses the content within the terms of the usage conditions defined in the license. In order to use the content beyond the terms of the usage conditions defined in the license, the user must obtain a new license or update the usage conditions of the license.

FIGS. 18 and 19 are flowcharts showing a license updating process performed by a client, and a license updating process performed by a license server, shown in the above-noted publication, respectively. The client registers itself in the license server in advance, and obtains service data including a leaf ID, a device node key (DNK), a private key and public key pair of the client, a public key of the license server, and certificates of the public keys.

The leaf ID indicates identification information assigned to each client, and the DNK is required for decoding an encrypted content key K_{C} included in an enabling key block (EKB) corresponding to the license.

As shown in FIG. 18, in step S91, a central processing unit (CPU) in a client communication terminal that is to update the license obtains a URL (Uniform Resource Location) corresponding to a desired license ID. The URL is an address to be accessed for obtaining a license identified by the license ID. In step S92, the CPU accesses the URL obtained in step S91. The license server requests that the client input license designation information for designating the license to be updated, a user ID, and a password. The CPU causes a display unit in an output unit to display the request. The user operates an input unit while viewing the display to input the license designation information, the user ID, and the password (steps S93 and S94). The user ID and the password are obtained in advance by the client user by accessing the license server via the Internet 2.

In response to the transmission processing of step S95, the license server provides usage conditions (in step S103 shown in FIG. 19, described below). In step S96, the CPU of the client receives the usage conditions from the license server, and outputs the received usage conditions to the output unit for display. The user operates the input unit to select a certain usage condition from the usage conditions or to add a required usage condition. In step S97, the CPU transmits a request for purchase of the selected usage condition (a condition for the updated license) to the license server. In response to this request, as described below, the license server transmits final usage conditions (in step S104 shown in FIG. 19, described below). In step S98, the CPU of the client obtains the usage conditions from the license server, and in step S99, the CPU uses these usage conditions to update the usage conditions for the corresponding license stored in a storage unit.

A license updating process performed by the license server in association with the license updating process performed by the client will be described with reference to FIG. 19. When the license server is accessed by the client in step S101, in step S102, a CPU of the license server receives the license designation information transmitted by the client in step S95 and license updating request information.

In step S103, upon receiving the license updating request, the CPU reads usage conditions (usage conditions to be updated) for the license from a storage unit, and transmits the read usage conditions to the client.

In response to the purchase request for the usage conditions from the client in step S97 shown in FIG. 18, in step S104, the CPU of the license server generates data corresponding to the requested usage conditions, and transmits the generated data to the client. As described above, the client updates the usage conditions for the registered license using the usage conditions received in step S99.

In this case, however, it is difficult for the client that updates the license to generate the same license as that issued by the license server, and the security can be lowered. A client having no license updating capability must have a plurality of licenses and must select a required license from these licenses. One license does not necessarily correspond to one digital content item. Even if one license corresponds to one digital content item, a plurality of licenses can be obtained for the same digital content item. If a client has a plurality of licenses for the same digital content item, these licenses are independently handled, and the client must select rights including the desired usage conditions. The client must therefore perform a time-consuming content using process.

### SUMMARY OF THE INVENTION

Accordingly, it is an object of the present invention to provide an information processing system and method for combining a plurality of rights and for obtaining high-security rights information regardless of the ability of a client information processing apparatus, and to provide an information processing apparatus and method for issuing a license in the information processing system.

In an aspect, the present invention provides an information processing system that communicates data between a communication terminal for obtaining a license including usage conditions of content, and a server connected to the communication terminal via a network. The communication terminal includes a transmitting unit that transmits first data including information about a first usage condition of the content and second data including information about a second usage condition of the content to the server, and a receiving unit that receives the data from the server. The server includes a receiving unit that receives the first and second data, a data generating unit that generates third data including information, about a third usage condition of the content based on the first and second data, and a transmitting unit that transmits the third data to the communication terminal. The communication terminal transmits the first and second data to the server, and receives the third data from the server.

When a communication terminal desires to update an existing license to add a new usage condition or desires to combine two licenses into one license, a server performs a license updating process, and returns an updated license to the communication terminal. Thus, the license can be safely updated regardless of the capabilities of the communication terminal.

The first data may include condition information that includes the first usage condition, and the second data may include condition information that includes the second usage condition. The data generating unit of the server may generate the third data including condition information that includes the third usage condition obtained by combining the first usage condition with the second usage condition. Therefore, a new usage condition can be added to condition information of an existing license.

The data generating unit of the server may generate the third data, which is signed with a private key owned only by the server. The license is therefore highly secure.

In another aspect, the present invention provides an information processing method for an information processing system that communicates data between a communication terminal for obtaining a license including usage conditions of content and a server connected to the communication terminal via a network. The method includes a data transmitting step of transmitting first data and second data from the communication terminal to the server, the first data including information about a first usage condition of the content, the second data including information about a second usage condition of the content, a data generating step of generating third data based on the first and second data when the server receives the first and second data, the third data including information about a third usage condition of the content, and a data receiving step of receiving the third data from the server to the communication terminal.

In another aspect, the present invention provides an information processing apparatus that issues a license including usage conditions of content. The apparatus includes a receiving unit that receives first data including information about a first usage condition of the content and second data including information about a second usage condition of the content from a communication terminal for obtaining the license, a data generating unit that generates third data including information about a third usage condition of the content from the first and second data, and a transmitting unit that transmits the third data to the communication terminal.

In the present invention, when a communication terminal transmits first data including information about a first usage condition and second data including information about a second usage condition, third data including a third usage condition based on the first and second data is transmitted to the communication terminal. Thus, a license can be updated on behalf of the communication terminal.

In another aspect, the present invention provides an information processing method for issuing a license including usage conditions of content. The method includes a receiving step of receiving first data and second data from a communication terminal for obtaining the license, the first data including information about a first usage condition of the content, the second data including information about a second usage condition of the content, a data generating step of generating third data from the first and second data, the third data including information about a third usage condition of the content, and a transmitting step of transmitting the third data to the communication terminal.

According to the present invention, therefore, a communication terminal for obtaining a license including usage conditions of content transmits first data including information about a first usage condition of the content and second data including information about a second usage condition of the content to a server. The server generates third data including information about a third usage condition of the content based on the first and second data, and transmits the third data to the communication terminal. For example, when the communication terminal that obtains a license desires to update the license to add a new usage condition to the existing license or desires to combine two licenses into one license, the communication terminal transmits the first and second data to the server, and the server updates the license and returns the updated license to the communication terminal. Thus, a communication terminal having limited capabilities, such as a communication terminal having only a communication function and a content playback function, can obtain the updated license. The server serving as a license issuer updates a license, and therefore provides a more secure service than a case in which the communication terminal updates a license.

### BRIEF DESCRIPTION OF THE DRAWINGS

FIG. 1 is a block diagram of a content providing system according to an embodiment of the present invention;

FIG. 2 is a configuration diagram showing the details of the content providing system;

FIG. 3 is a block diagram of a client;

FIG. 4 is a chart showing a license updating process between a license server and a client;

FIG. 5 is a diagram showing the relation between content and a license;

FIG. 6 is a functional block diagram of a client;

FIG. 7 is a functional block diagram of a server;

FIG. 8 is a configuration diagram of an existing or new rights file;

FIG. 9 is a flowchart showing a license updating process performed by the client in the content providing system according to the embodiment of the present invention;

FIG. 10 is a flowchart showing a license updating process performed by the server in the content providing system according to the embodiment of the present invention;

FIG. 11 is a flowchart showing the details of a process for updating an existing license information in the flowchart shown in FIG. 10;

FIG. 12 is a flowchart showing a content downloading process performed by the client;

FIG. 13 is a flowchart showing a content providing process performed by the content server;

FIG. 14 is a flowchart showing a content playback process performed by the client;

FIG. 15 is a flowchart showing a license obtaining process performed by the client;

FIG. 16 is a configuration diagram of a license;

FIG. 17 is a flowchart showing a license providing process performed by the license server;

FIG. 18 is a flowchart showing a license updating process performed by a client of the related art; and

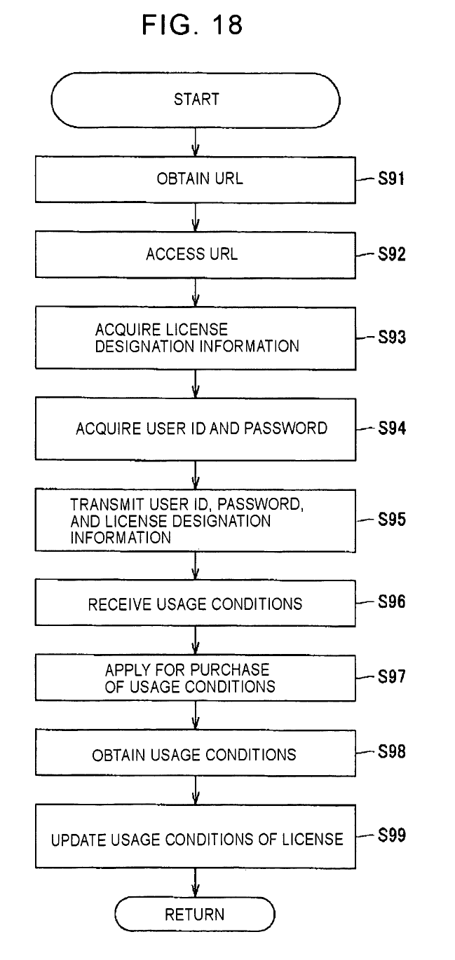

FIG. 19 is a flowchart showing a license updating process performed by a license server of the related art.

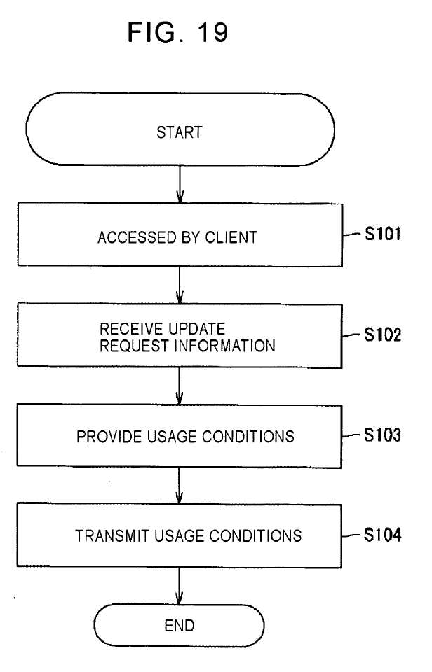

### DESCRIPTION OF THE PREFERRED EMBODIMENTS

A content providing system according to an embodiment of the present invention will be described in detail with reference to the drawings. The content providing system is constituted by a communication device (hereinafter referred to as a “client”) that obtains a license including content usage conditions, and a license server that issues a license.

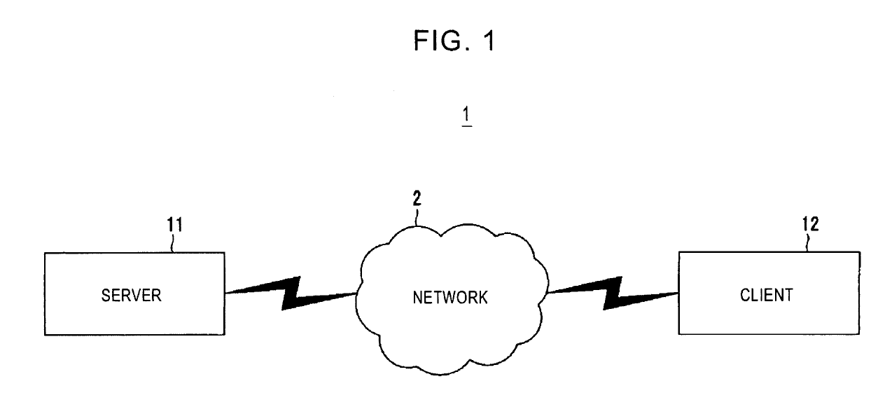

FIG. 1 is a block diagram of a content providing system 1 according to the present invention. The content providing system 1 handles video and/or audio data. A server 11 is connected to a client 12 via a network 2, such as the Internet. Although one client 12 is shown in FIG. 1, any number of clients 12 may be connected to the Internet 2.

The client 12 is an information processing apparatus that is allowed to use the content under a range of usage conditions described in license information described below. The client 12 stores existing license information including a first usage condition in a storage unit. The client 12 receives a usage condition to be additionally purchased, which is additional difference information specifying a second usage condition, via a communication unit and transmits the additional difference information and the existing license information to the server 11 together with a client certificate obtained in advance for certifying the client 12. The server 11 updates the existing license information based on the additional difference information indicating the additionally purchased usage condition. The client 12 receives the updated license information as data specifying a third usage condition. The client 12 is allowed to use the content under the updated license information.

In this embodiment, the server 11 adds a new usage condition to an existing license in a license updating process. The server 11 may combine two or more licenses of the client 12 into one license to produce the updated license. Prior to the license updating process, a content downloading operation and an existing-license obtaining operation are performed between the client 12 and the server 11, as described below.

In response to a request from the client 12, the server 11 transmits additional difference information to be additionally purchased to the client 12. Upon receiving a client certificate, existing license information, and additional difference information from the client 12, the server 11 confirms that a signature of the server 11 included in the existing license information is not altered, and further confirms that a signature of the server 11 included in the certificate of the client 12 is not altered. The server 11 also compares the existing license information with client unique information included in the client certificate to verify the likelihood of the existing license information, the additional difference information, and the client certificate.

After verification, the server 11 updates the existing license information based on the additional difference information only when either information is not tampered with. For example, when the number of playbacks allowed in the existing license information of the client 12 is five, and the client 12 desires five more playbacks, additional difference information indicating five playbacks (additional playbacks) allowed is transmitted, and the server 11 updates the existing license information so as to allow a total of 10 playbacks. The updated license information is transmitted from the server 11 to the client 12.

The server 11 may also provide content to the client 12 or may bill the client 12 for the license.

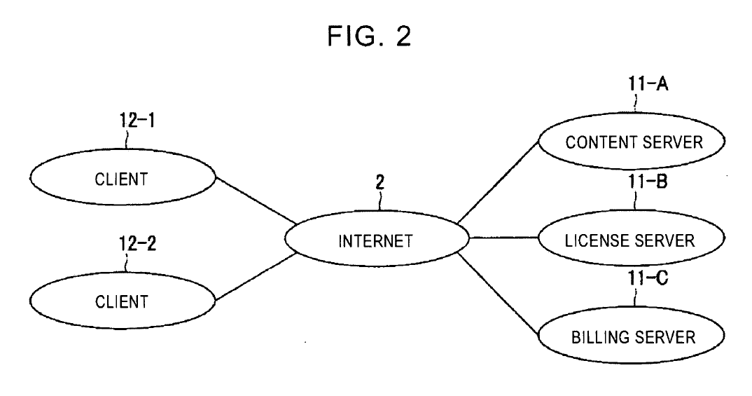

FIG. 2 is a block diagram showing the detailed configuration of the content providing system 1. Clients 12-1 and 12-2 (hereinafter referred to simply as a client 12 if these clients need not be individually identified) are connected to the Internet 2. As described above, any number of clients may be connected to the Internet 2. A content server 11-A for providing content to the client 12, a license server 11-B for providing a license required for using the content provided by the content server 11-A to the client 12, and a billing server 11-C for billing the client 12 for the license received by the client 12 are also connected to the Internet 2.

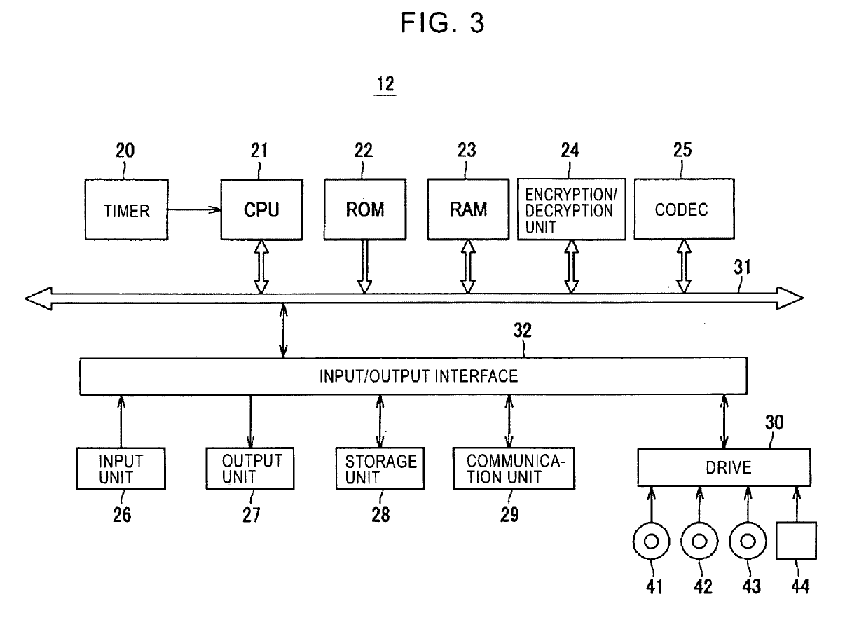

FIG. 3 is a block diagram showing the structure of the client 12. In FIG. 3, a CPU 21 executes processing in accordance with a program stored in a read only memory (ROM) 22 or a program loaded from a storage unit 28 to a random access memory (RAM) 23. A timer 20 counts the time, and supplies time information to the CPU 21. The RAM 23 also stores data, etc., necessary for the CPU 21 to execute processing, as required.

An encryption/decryption unit 24 encrypts content data, and decrypts encrypted content data. A codec 25 encodes content data using a technique such as ATRAC3 (Adaptive Transform Acoustic Coding 3), and supplies the encoded data via an input/output interface 32 to a semiconductor memory 44 connected to a drive 30 for recording. The codec 25 also decodes encoded data read from the semiconductor memory 44 via the drive 30. The semiconductor memory 44 is commercially available as a memory card.

The CPU 21, the ROM 22, the RAM 23, the encryption/decryption unit 24, and the codec 25 are connected with one another via a bus 31. The input/output interface 32 is also connected to the bus 31.

The input/output interface 32 is connected to an input unit 26 including a keyboard and a mouse, an output unit 27 including a display, such as a cathode ray tube (CRT) or a liquid crystal display (LCD), and a speaker, the storage unit 28 including a hard disk, a communication unit 29 including a modem and a terminal adapter.

The communication unit 29 performs communication via the Internet 2, and transmits data supplied from the CPU 21. The communication unit 29 also outputs data received from a communicating party to the CPU 21, the RAM 23, and the storage unit 28. The storage unit 28 communicates with the CPU 21, and stores or deletes information. The communication unit 29 also communicates an analog or digital signal with another client.

The drive 30 is connected to the input/output interface 32, if necessary. A magnetic disk 41, an optical disk 42, a magneto-optical disk 43, the semiconductor memory 44, or the like is appropriately mounted to the drive 30, and a computer program read therefrom is installed in the storage unit 28, as required.

The content server 11-A, the license server 11-B, and the billing server 11-C are also constituted by a computer having a basically similar structure to that of the client 12 shown in FIG. 3. In the following description, the structure shown in FIG. 3 is also referred to for denoting the structure of the server 11.

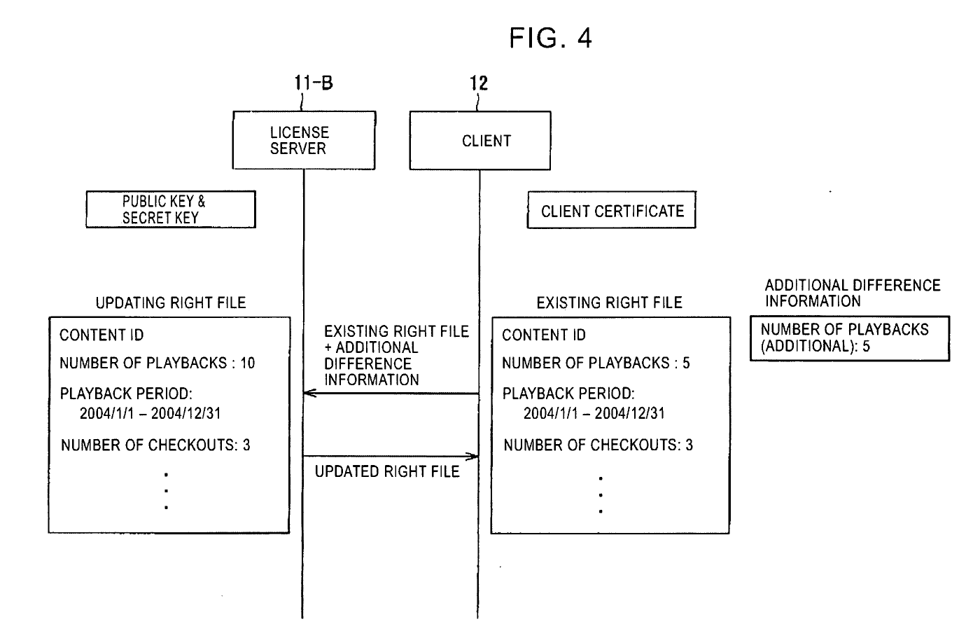

In the content providing system 1, as shown in FIG. 4, the client 12 transmits an existing rights file including existing license information, and additional difference information to be added to the existing license to the license server 11-B.

The existing rights file includes at least a content ID and usage rights for using the content, including information specifying various usage conditions defined in the existing license, e.g., the time until which the content can be played back, the number of times the content can be played back, the number of times the content can be copied to media such as CDs, the number of times the content can be checked out to portable devices (PDs), etc. When the client 12 plays back the content, a license for the content to be played back is required. Thus, the existing rights file further includes a content ID for identifying the content. When a usage condition in the information specifying the above-noted usage conditions is to be added, e.g., five more playbacks are desired, additional difference information specifying five more playbacks is transmitted.

Upon receiving the additional difference information, the license server 11-B updates the usage condition in the existing license to generate an updated license as a new license. The updated license is signed with a private key owned only by the license server 11-B to produce an updated rights file, and the updated rights file is then transmitted to the client 12. In FIG. 4, the existing license indicates five playbacks allowed, and the additional difference information indicates five more playbacks. Thus, a total of ten playbacks are now allowed in the updated rights file.

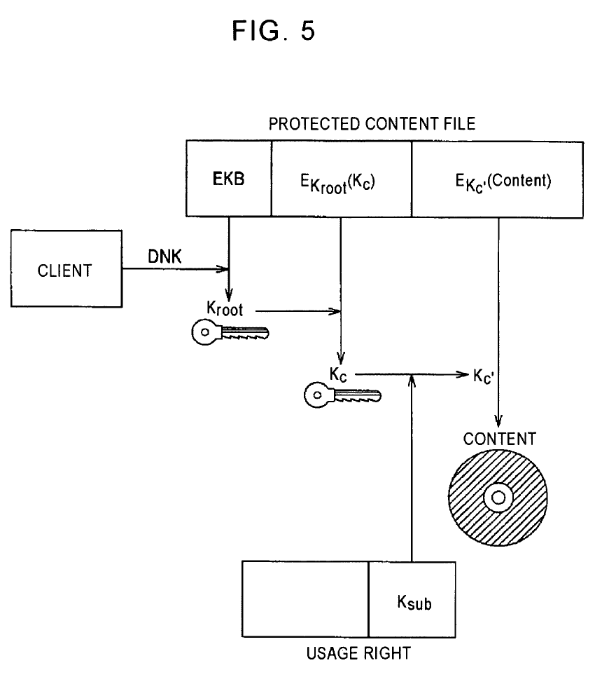

As shown in FIG. 5, the content is constituted by a content body and keys, and the content body is encrypted with the keys. The client 12 decodes and plays back the content body based on the received content and license information.

In this embodiment, the client 12 is an information processing apparatus that is allowed to use the content under a range of usage conditions described in the license information. The client 12 stores existing license information in the storage unit 28, and receives additional difference information via the communication unit 29. The client 12 transmits the existing license information and the additional difference information from the communication unit 29, and receives the updated license information via the communication unit 29. The client 12 uses the content under the updated license information.

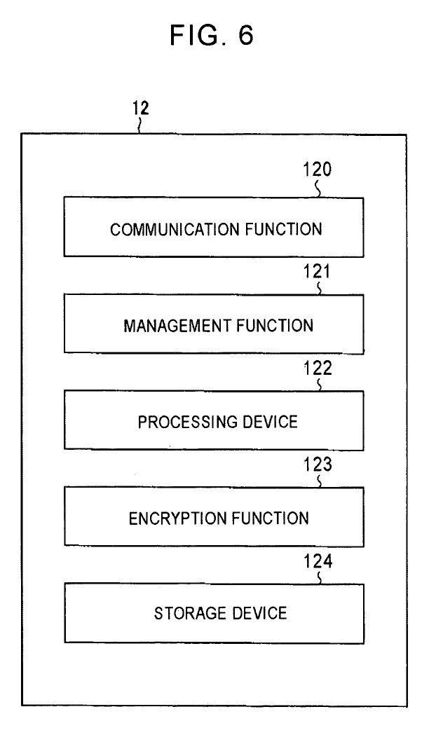

The client 12 functions as function blocks shown in FIG. 6 under the control of the CPU 21. A communication function 120 of the client 12 receives a message from the server 11, and passes the message to a management function 121. The communication function 120 also transmits a message received from the management function 121 to the server 11. An encryption function 123 encrypts and decrypts a message using a client private key shared with the server 11. The client private key is a private key in communication that is generated and shared by both parties during the communication. A processing device 122 generates and analyzes a message partially using the encryption function 123. A storage device 124 corresponds to the storage unit 28, and stores the existing license information. The storage device 124 also stores the license information updated by the server 11.

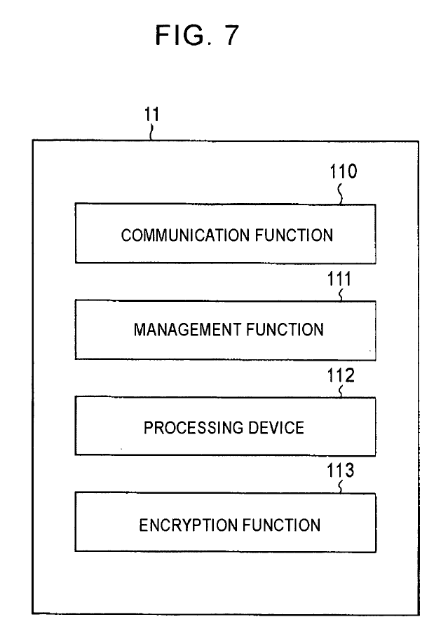

The server 11 functions in accordance with function blocks shown in FIG. 7 under the control of the CPU 21. A communication function 110 receives a message from the client 12, and passes the message to a management function 111. The communication function 110 also transmits a message received from the management function 111 to the client 12. An encryption function 113 encrypts and decrypts a message using the client private key shared with the client 12 or a private key owned only by the server 11. The management function 111 exchanges a message with the client 12 via the communication function 110, and appropriately processes the message. The management function 111 partially uses the encryption function 113 to generate and analyze a message. A processing device 112 performs processing requested by the management function 111.

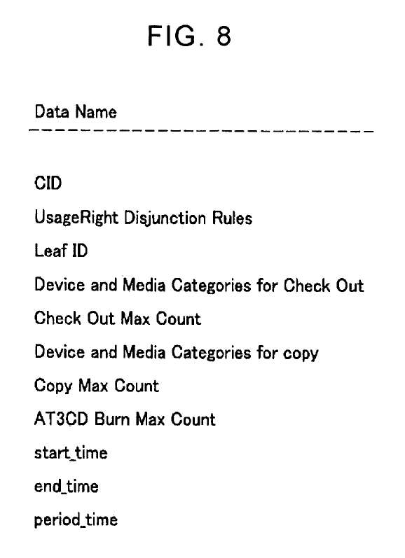

FIG. 8 shows the simplified data structure of an existing rights file including license information. The updated rights file including updated license information also has a similar data structure. In the following description, the existing rights file and the updated rights file are sometimes referred to collectively as a rights file. The data structure of the rights file is provided for each content item. A plurality of rights files may be provided for each content item, or one rights file may be provided for a plurality of content items.

As shown in FIG. 8, “data name” is first described in a rights file. The rights file further includes “content ID (CID)”, “usage right disjunction rules”, “leaf ID” serving as a terminal ID, “device and media categories for check out” indicating categories of checkout terminals and media, “check out max count” indicating the maximum number of checkouts allowed, “device and media categories for copy” indicating categories of copiable terminals and media, and “copy out max count” indicating the maximum number of copies allowed. The rights file further describes “AT3CD burn max count” indicating the maximum number of times the content can be duplicated to CDs by ATRAC3, “start_time” indicating the absolute start time, “end_time” indicating the absolute end time, and “period_time” indicating the relative period of time. A single rights file may or may not include all pieces of information noted above, or may include any piece of or a plurality of pieces of information of the above-noted information. In a rights file including a plurality of pieces of information, for example, a flag for specifying a PD to which the content can be checked out is associated with number-of-checkouts information for specifying the number of checkouts allowed, as described below.

The content ID is an identification code for identifying the content associated with this rights file (i.e., the existing rights file or the updated rights file). The same ID, i.e., the identification code for identifying the rights file associated with the content is also described in a content file. The ID is signed to prevent tampering.

The “usage right disjunction rules” are independent rules that can be set by turning on or off a flag. Several independent conditions are specified in this field. For example, this field has four bytes. Specifically, bit 0 may be assigned to a flag for determining whether or not the bit rate is converted, and the remaining bits 1 to 31 are reserved for later rule flags.

The “leaf ID” is an identification number of each device.

The “device and media categories for check out” specifies devices and media to which the content can be checked out from the client 12. The term checkout means transferring content from a client to a portable device (PD). The “device and media categories for check out” is therefore a flag indicating a portable device to which the content can be transferred from the client 12. For example, three categories are defined: a network-based Mini Disk (MD) recording and playback device capable of recording music data over the Internet, a timer-equipped portable device, and a portable device without a timer. If flag “1” indicates checkout allowed, “110” indicates that the PDs to which the content can be transferred from the client 12 are a network-based MD recording and playback device and a timer-equipped portable device while the content cannot be checked out to a portable device without a timer. The term check-in means that content checked out from a client to a PD is returned to the client from the PD. The content that was checked out from a client to a PD may be returned to the client by check-in, and may be then checked out.

The “check out max count” specifies the maximum number of times the content can be checked out to a portable device designated by the “device and media categories for check out”.

The “device and media categories for copy” specifies devices and media to which the content can be copied from the client 12. The term copy means duplicating content from a client to a portable device (PD). The “device and media categories for copy” is therefore a flag indicating a portable device to which the content can be duplicated from the client 12. For example, as in the “device and media categories for check out”, three categories are defined: a network-based MD recording and playback device, a timer-equipped portable device, and a portable device without a timer. If flag “1” indicates copying allowed, “110” indicates that the PDs to which the content can be copied from the client 12 are a network-based MD recording and playback device and a timer-equipped portable device while copying to a portable device without a timer is prohibited.

The “copy out max count” specifies the maximum number of times the content can be copied to a portable device designated by the “device and media categories for copy”.

The “AT3CD burn max count” specifies the maximum number of times the content can be duplicated to CDs by ATRAC3 codec.

The absolute start time “start_time” indicates the absolute time from which the content can be used, and the absolute end time “end_time” indicates the absolute time until which the content can be used. The absolute period of time during which the content can be used is specified by the “start_time” and the “end_time”.

The relative period of time “period_time” indicates how long the content can be used from a designated time.

The above-noted information may be classified into information that specifies a period of time, information that specifies flags, and information that specifies the number of times. The “start_time”, the “end_time”, and the “period_time” may be classified as the information that specifies a period of time. The “usage right disjunction rules”, the “device and media categories for check out”, and the “device and media categories for copy” may be classified as the information that specifies flags. The “check out max count”, the “copy out max count”, and the “AT3CD burn max count” may be classified as the information that specifies the number of times.

In the existing and updated rights files in the license information described above, the additional difference information transmitted together with the existing rights file to the server 11 may be, for example, information that specifies only additional checkout devices or information that specifies only an additional number of playbacks, or may be configured in a similar manner to the existing and updated rights files.

The details of a process for the license server 11-B to update an existing rights file of the client 12 based on the additional difference information to generate an updated rights file will be described.

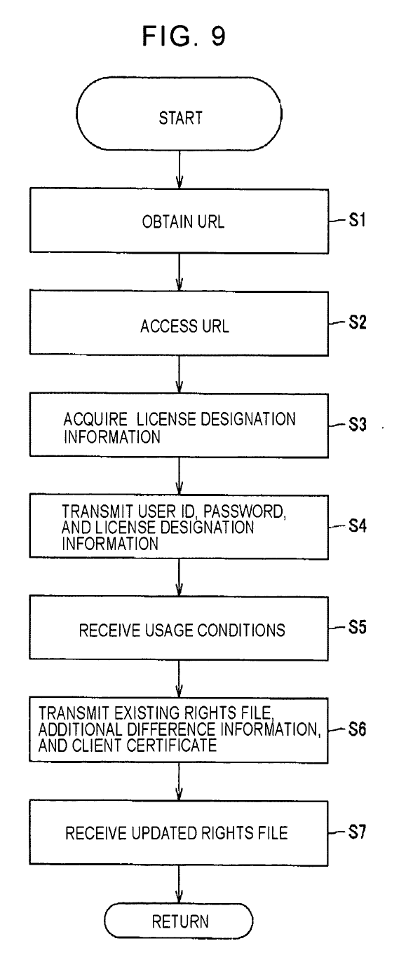

FIG. 9 is a flowchart showing a license updating process performed by the client 12. The client 12 registers itself in the license server 11-B in advance, and obtains service data including a leaf ID, a device node key (DNK), a private key and public key pair of the client 12, a public key of the license server 11-B, and certificates of the public keys. The client 12 also obtains a client certificate for certifying the client 12. The client certificate is signed with, for example, a private key owned only by the server 11-B to prevent the content from being tampered with by the client 12 or the like.

The leaf ID indicates identification information assigned to each client, and the DNK is required for decoding an encrypted content key KC included in an enabling key block (EKB) corresponding to the license. The content is obtained by a content obtaining process described below. The content is composed of content data and a header, and the header includes a license ID for designating the license required for using the content, an address (URL) of the license server 11-B, and so on.

In step S1, the CPU 21 of the client 12 obtains a URL corresponding to the required license ID. As described above, the URL is an address to be accessed for obtaining the license identified by the license ID recorded in the header of the content. In step S2, the CPU 21 accesses the URL obtained in step S1. The license server 11-B requests that the client 12 input license designation information designating the license to be updated, or the license ID, a user ID, and a password. The CPU 21 causes a display unit in the output unit 27 to display the request (step S3). The user operates the input unit 26 while viewing the display to input the license designation information, the user ID, and the password (step S4). The user ID and the password are obtained in advance by the user of the client 12 by accessing the license server 11-B via the Internet 2.

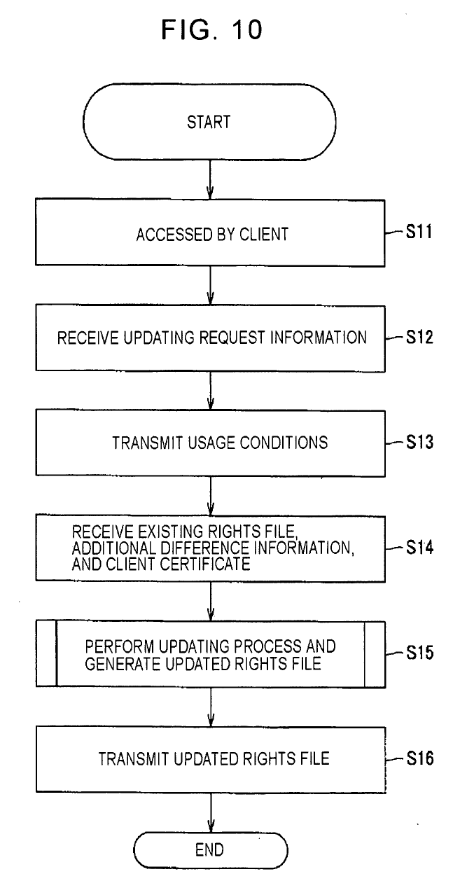

In step S5, the CPU 21 of the client 12 receives the usage conditions provided from the license server 11-B (in step S13 shown in FIG. 10, described below) in association with transmission of the user ID and the password in step S4, and outputs the received usage conditions to the output unit 27 for display. The user operates the input unit 26 to select a certain usage condition from the usage conditions or add a required usage condition.

When information indicating the number of times a certain function in a rights file can be performed, e.g., the number of playbacks, copies, or checkouts allowed shown in FIG. 8, which is specified by the existing rights file, is added, the client 12 obtains a usage condition for the content, including the additional condition of the content, from the server 11, and produces additional difference information specifying a desired number of times the content can be used.

When a period of time for a certain function in a rights file, e.g., the start_time, the end_time, or the period_time shown in FIG. 8, which is specified by the existing rights file, is extended, the client 12 obtains a usage condition for the content, including the additional condition of the content, from the license server 11-B, and produces additional difference information specifying a desired period of time during which the content can be used.

In step S6, the client 12 transmits the existing rights file to be updated, the additional difference information, and the certificate of the client 12 to the license server 11-B. In step S7, the client 12 receives an updated rights file that has been updated by the license server 11-B based on the additional difference information and that has been signed with the private key of the license server 11-B.

Thus, the client 12 is allowed to use the content under the updated license information in which the additional difference information is added to the existing license.

A license updating process performed by the license server 11-B in association with the license updating process performed by the client 12 will be described.

When license server 11-B is accessed by the client 12 in step S11, in step S12, the CPU 21 of the license server 11-B receives the license designation information transmitted by the client 12 in step S4 together with license updating request information.

Upon receiving the license updating request, in step S13, the CPU 21 reads the usage condition for the license (the usage condition to be updated) from the storage unit 28, and transmits the read usage condition to the client 12.

As described above, this usage condition is additional difference information used to add the desired usage condition on the client 12. The license server 11-B receives the additional difference information, the existing rights file, and the client certificate (step S14). In step S15, the CPU 21 of the license server 11-B updates the existing license information based on the additional difference information. In step S16, the CPU 21 of the license server 11-B signs the updated rights information using the private key of the license server 11-B, and transmits an updated rights file including the signed rights information to the client 12.

The process for updating the existing license information in step S15, which is performed by the license server 11-B, will be described.

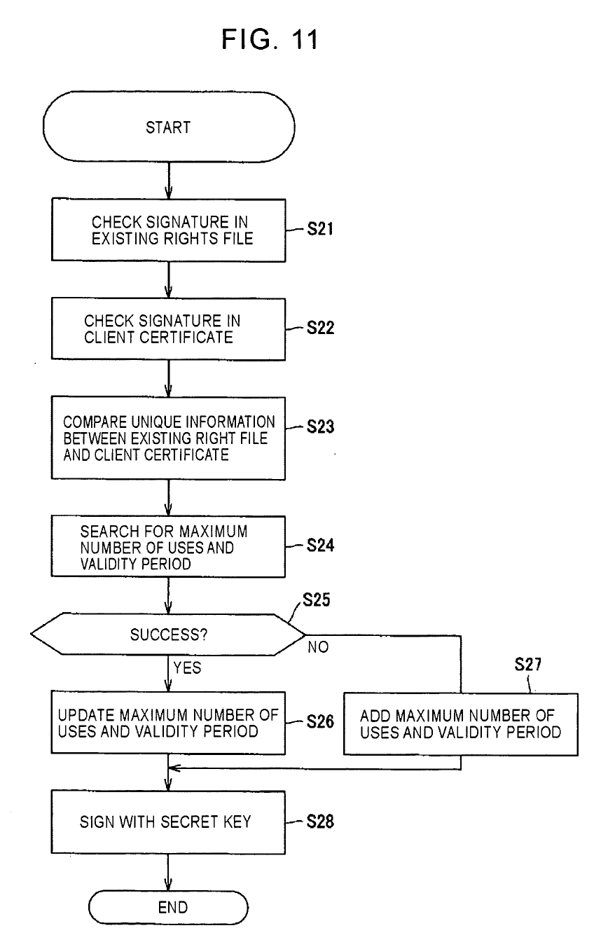

Referring to FIG. 11, upon receiving the existing rights file, the additional difference information, and the client certificate in step S14 shown in FIG. 10, the CPU 21 of the license server 11-B checks the signature of the license server 11-B included in the rights file, and confirms that the rights file is not tampered with by the client 12 (step S21).

The CPU 21 of the license server 11-B also checks the signature of the license server 11-B included in the client certificate, and confirms that the client certificate is not tampered with by the client 12 (step S22).

When it is confirmed that the existing rights file and the client certificate are not tampered with, the CPU 21 of the license server 11-B compares client unique information included in the rights file with client unique information included in the client certificate. The existing rights file and the client certificate include client unique information, e.g., a leaf ID. Spoofing of the client 12 is checked by comparing the client unique information between the rights file and the client certificate (step S23).

After the existing rights file and the client certificate are verified in steps S21 to S23, the existing license information is updated.

When information indicating the number of uses is transmitted as the additional difference information, and rights information indicating the number of times a designated function can be used is updated, in step S24, the CPU 21 of the license server 11-B searches the rights file for the maximum number of times the designated function can be used based on the additional difference information.

If the maximum number of uses is searched for in step S24, a sum of the number of uses to be added, which is specified by the additional difference information, and the maximum number of uses, which is specified by the existing rights file, is set as the updated maximum number of uses. If the same function as that specified in the additional difference information is not searched for in step S25, that is, if the number of times a designated function can be used is not searched for in this embodiment, in step S27, the rights for permitting the designated function are added to the existing rights file, and an additional number of uses, which is included in the additional difference information, is set to the maximum number of uses.

When information indicating a period of time is obtained as the additional difference information, and rights information indicating the validity period of a designated function is updated, in step S24, the CPU 21 of the license server 11-B searches the rights file for the validity period based on the additional difference information.

If the validity period is searched for in step S25, then in step S26, a sum of the period of time to be added and the existing validity period is set as a new validity period. If the validity period is not searched for in step S25, then in step S27, the rights for permitting the designated function and a validity period indicating an additional period of time for the designated function are added to the rights file.

In step S28, the CPU 21 of the license server 11-B signs the rights information in which the number of uses or the validity period is updated in step S26 or the rights information to which the number of uses or the validity period is added in step S27 using the private key of the license server 11-B. Then, an updated rights file is generated.

In this embodiment, therefore, the license server 11-B can update the number of uses or validity period in a rights file including license information of the content.

The process for a client having existing license information to purchase additional rights information has been described. A process for providing content from the content server 11-A to the client 12 and a process for obtaining a license for using the content will be described.

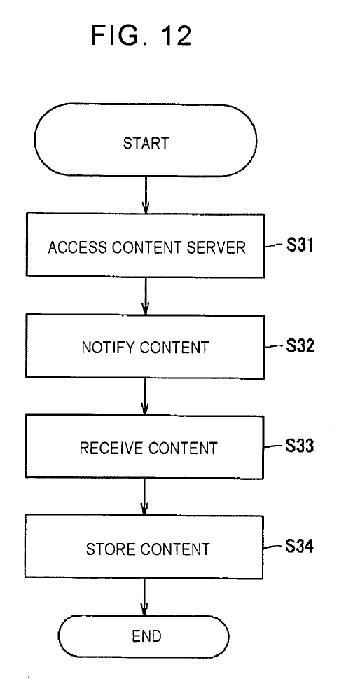

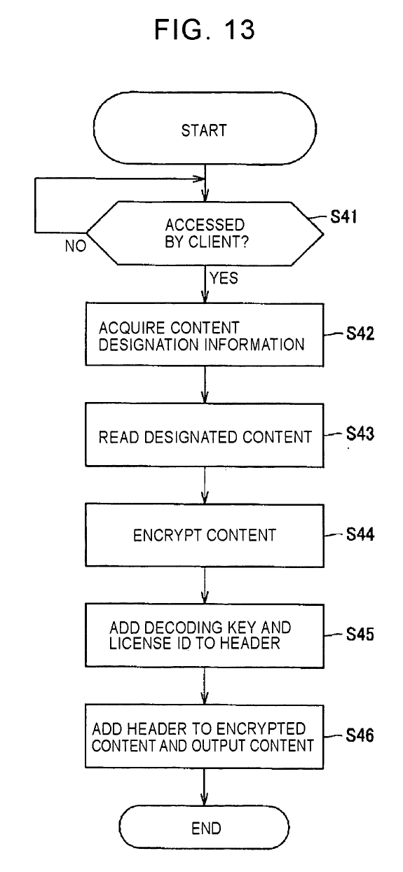

FIG. 12 is a flowchart showing a content downloading process performed by the client 12. As shown in FIG. 12, when the user operates the input unit 26 to instruct an access to the content server 11-A, in step S31, the CPU 21 controls the communication unit 29 serving as the communication function 120 using the management function 121 to access the content server 11-A via the Internet 2. When the user operates the input unit 26 to designate the content to be provided, in step S32, the CPU 21 receives the designation information using the management function 121, and notifies the content server 11-A of the designated content via the communication unit 29 over the Internet 2. As described below with reference to FIG. 13, upon receiving the notice, the content server 11-A transmits encrypted content data. In step S33, the CPU 21 receives the content data via the communication unit 29. In step S34, the encrypted content data is supplied to a hard disk constituting the storage unit 28 for storage.

FIG. 13 is a flowchart showing a content providing process performed by the content server 11-A in association with the content downloading process of the client 12 shown in FIG. 12. In the following description, the structure of the client 12 shown in FIG. 3 is also used as the structure of the content server 11-A.

In step S41, the CPU 21 of the content server 11-A waits for access from the client 12 via the communication unit 29 over the Internet 2. When it is determined that the content server 11-A is accessed, in step S42, the content designation information transmitted from the client 12 is received. The content designation information is sent by the client 12 in step S32 shown in FIG. 12.

In step S43, the CPU 21 of the content server 11-A reads the content designated by the information received in step S42 from the content data stored in the storage unit 28. In step S44, the CPU 21 supplies the content data read from the storage unit 28 to the encryption/decryption unit 24 to encrypt the content data using the content key K_{C}.

The content data stored in the storage unit 28 has been encoded by the codec 25 using ATRAC3. In step 44, the encoded content data is encrypted.

Encrypted content data may be stored in the storage unit 28. In this case, the processing of step S44 is omitted.

In step S45, the CPU 21 of the content server 11-A adds key information required for decoding the encrypted content, a license ID for identifying the license required for using the content, address information (URL) to be accessed when the license identified by the license ID is obtained, etc., to the header of the encrypted-content-data transmission format. In step S46, the CPU 21 of the content server 11-A transmits the data obtained by formatting the content encrypted in step S44 and the header to which the key and the license ID are added in step S45 from the communication unit 29 to the accessing client 12 over the Internet 2.

Therefore, the client 12 obtains the content from the content server 11-A.

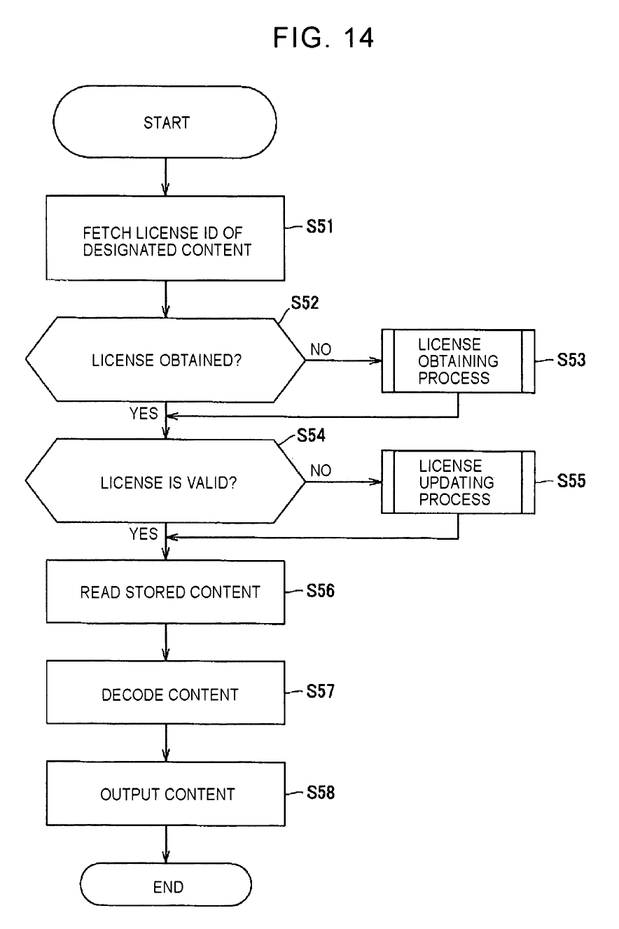

In order to play back the obtained content, the license information shown in FIG. 8 is required. A content playback process performed by the client 12 will be described with reference to FIG. 14.

In step S51, the CPU 21 of the client 12 obtains content identification information (CID) of the content designated by the user by operating the input unit 26. The identification information is constituted by, for example, the content title, the number assigned to each content item stored therein, etc.

When the content is designated, the CPU 21 reads the license ID corresponding to the designated content (i.e., an ID of the license required for using the content). The license ID is described in the header of the encrypted content data.

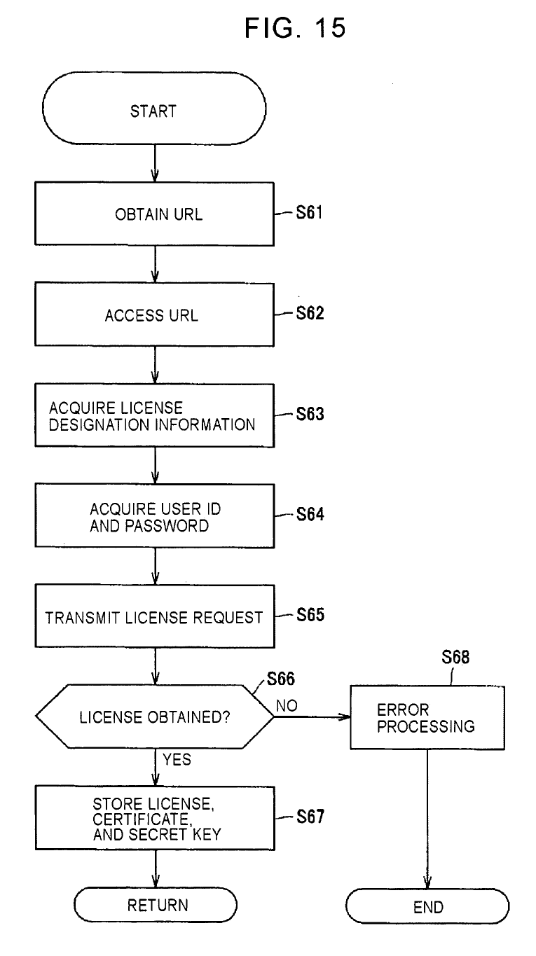

In step S52, the CPU 21 determines whether or not the license identified by the license ID read in step S51 has been obtained by the client 12 and stored in the storage unit 28. If the license has not been obtained, in step S53, the CPU 21 performs a license obtaining process, described in detail below with reference to FIG. 15.

If it is determined in step S52 that the license has been obtained or if the license is obtained after the license obtaining process in step S53, in step S54, the CPU 21 determines whether or not the obtained license is valid. This determination is performed by comparing the expiration date defined in the license with the current time determined by the timer 20. If it is determined that the license has been expired, in step S55, the CPU 21 performs the license updating process described above.

If it is determined in step S54 that the license is valid or if the license is updated in step S55, in step S56, the CPU 21 reads the encrypted content data from the storage unit 28, and stores it in the RAM 23. In step S57, the CPU 21 supplies the data of the encrypted blocks stored in the RAM 23 to the encryption/decryption unit 24 in units of encrypted blocks to decode the encrypted content data using the content key K_{C}.

A specific method for obtaining the content key K_{C} is, for example, to obtain a key K_{EKBC} included in an enabling key block (EKB) using a device node key (DNK) and to obtain the content key K_{C} from data K_{EKBC}(K_{C}) using the key K_{EKBC}.

In step S58, the CPU 21 supplies the content data decoded by the encryption/decryption unit 24 to the codec 25 for decoding. The CPU 21 supplies the data decoded by the codec 25 to the output unit 27 via the input/output interface 32 to output the decoded data from the speaker after performing digital-to-analog (D/A) conversion.

The license obtaining process in step S53 shown in FIG. 14 will be described in detail with reference to FIG. 15.

The client 12 registers itself in the license server 11-B in advance to obtain service data including a leaf ID, a DNK, a private key and public key pair of the client 12, a public key of the license server 11-B, and certificates of the public keys.

The leaf ID indicates identification information assigned to each client, and the DNK is required for decoding an encrypted content key K_{C} included in an EKB corresponding to the license.

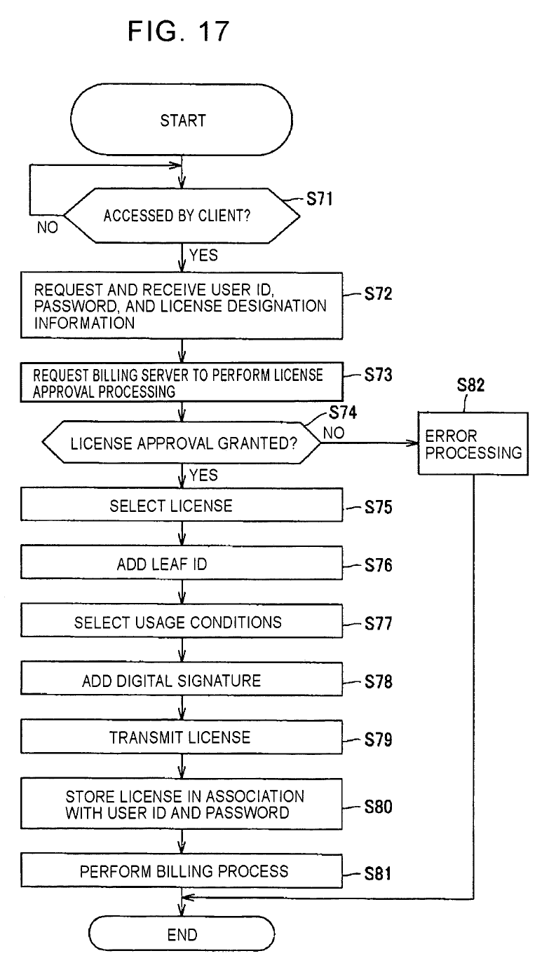

In step S61, the CPU 21 obtains the URL corresponding to the required license ID from the header of the content-data transmission format. As described above, the URL is an address to be accessed when the license identified by the license ID included in the header is obtained. In step S62, the CPU 21 accesses the URL obtained in step S61. Specifically, the CPU 21 accesses the license server 11-B via the communication unit 29 over the Internet 2. The license server 11-B requests that the client 12 input license designation information designating the license to be purchased (or the license required for using the content), a user ID, and a password (in step S72 shown in FIG. 17, described below). The CPU 21 displays the request on the display unit of the output unit 27. The user operates the input unit 26 while viewing the display to input the license designation information, the user ID, and the password. The user ID and the password are obtained in advance by the user of the client 12 by accessing the license server 11-B via the Internet 2.

In steps S63 and S64, the CPU 21 receives the license designation information, user ID, and password input from the input unit 26. In step S65, the CPU 21 controls the communication unit 29 to transmit a license request including the input user ID, password, and license designation information, and the leaf ID included in the service data (described below) to the license server 11-B via the Internet 2.

The license server 11-B transmits a license based on the user ID, the password, and the license designation information (step S79 shown in FIG. 17, described below), or does not transmit a license if the conditions are not met (step S82 shown in FIG. 17, described below).

In step S66, the CPU 21 determines whether or not the license has been transmitted from the license server 11-B. If the license has been transmitted, in step S67, the license is supplied to the storage unit 28 for storage.

If it is determined in step S66 that the license has not been transmitted, in step S68, the CPU 21 performs an error process. Specifically, the CPU 21 prohibits the content from being played back due to lack of the license for using the content.

Therefore, the client 12 is not allowed to use the content unless the license identified by the license ID attached to the content data is obtained.

The license obtaining process shown in FIG. 15 may be performed before each user obtains content.

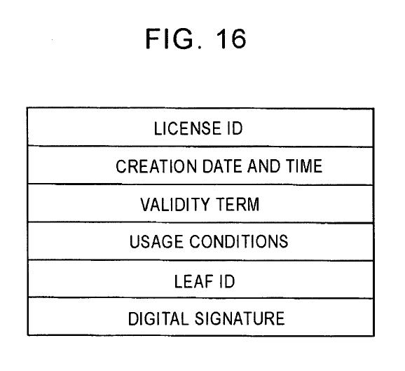

FIG. 16 shows the license provided to the client 12, in which the rights file shown in FIG. 8 is included in usage conditions.

A license providing process performed by the license server 11-B in association with the license obtaining process performed by the client 12 shown in FIG. 15 will be described with reference to FIG. 17. The structure of the client 12 shown in FIG. 3 is also used as the structure of the license server 11-B.

In step S71, the CPU 21 of the license server 11-B waits for access from the client 12. When it is accessed by the client 12, in step S72, the CPU 21 of the license server 11-B requests that the accessing client 12 transmit a user ID, a password, and license designation information. The CPU 21 of the license server 11-B receives via the communication unit 29 the user ID, the password, the leaf ID, and the license designation information (license ID) transmitted from the client 12 in step S65 shown in FIG. 15 described above.

In step S73, the CPU 21 of the license server 11-B accesses the billing server 11-C from the communication unit 29, and requests an examination whether or not the license is approved to the user identified by the user ID and the password. Upon receiving the request for the examination from the license server 11-B via the Internet 2, the billing server 11-C checks the past payment records, etc., of the user identified by the user ID and the password, and determines whether or not there is any non-payment record of this user for the previous licenses. If there is no non-payment record, an examination result indicating that license approval is granted is transmitted, whereas, if there is a non-payment record, an examination result indicating that license approval is not granted is transmitted.

In step S74, the CPU 21 of the license server 11-B determines whether or not the examination result of the billing server 11-C indicates license approval. If the license approval is determined, in step S75, the license corresponding to the license designation information received in step S72 is fetched from the licenses stored in the storage unit 28. The licenses stored in the storage unit 28 include information such as a license ID, the version number, the creation date and time, and the validity term. In step S76, the CPU 21 adds the received leaf ID to the license. In step S77, the CPU 21 selects the usage conditions associated with the license selected in step S75. If the user specifies a usage condition in step S72, the specified usage condition is added to pre-defined usage conditions, if necessary. The CPU 21 adds the selected usage conditions to the license.

In step S78, the CPU 21 signs the license with the private key of the license server 11-B to generate the license shown in FIG. 16.

In step S79, the CPU 21 of the license server 11-B transmits the license shown in FIG. 16 to the client 12 via the communication unit 29 over the Internet 2.

In step S80, the CPU 21 of the license server 11-B stores the license (including the usage conditions and the leaf ID) transmitted in step S79 in association with the user ID and password received in step S72 into the storage unit 28. In step S81, the CPU 21 performs a billing process. Specifically, the CPU 21 sends a request for billing the user identified by the user ID and the password from the communication unit 29 to the billing server 11-C. The billing server 11-C bills the user based on the billing request. As described above, if the user does not pay the bill, the user cannot be licensed in the future even if the user requests a license.

Thus, the client 12 and the license server 11-B perform the license obtaining and providing processes. The client 12 transmits desired additional difference information to the license server 11-B, if necessary, and, as described above, the license server 11-B updates the license.

In this embodiment, when the client 12 desires to update a license, the license is updated by the license server 11-B. Thus, a high-security system can be provided. When a rights file is transmitted from the server 11 in response to a request from the client 12, the server 11 transmits a rights file signed with a signature private key owned only by the server 11. For example, a set of a rights file, a server certificate, and a signature is transmitted to the client 12. The client 12 decodes the signature using the public key of the server, and determines whether or not the decoded signature is matched to the rights file to determine whether or not the rights file is tampered with.

In a case where a license is updated by the client 12, the client 12 does not have a signature private key owned only by the server, and the rights file updated by the client 12 cannot be signed with the same signature as that of the server 11. In this case, the client 12 signs the updated rights file with, for example, a signature private key owned only by the client 12, and saves the signed rights file. However, if the client 12 is a communication terminal having no capability of signing an updated rights file and having no capability of updating a license, the client 12 cannot update a license.

The client 12 cannot sign a rights file with the same signature as that of the server 11, resulting in the lack of security. A problem occurs in security if the client 12 has a signature private key of the server 11.

In this embodiment, however, in order to update a license, an existing rights file and additional difference information to be updated are transmitted to the license server 11-B, and the license server 11-B updates the license. Thus, the updated license with a signature of the license server 11-B can be obtained regardless of the processing capability of the client 12, and the license can be safely updated.

The client according to the information processing apparatus of the present invention may be a personal computer, a personal digital assistant (PDA), a portable telephone, a game terminal, or the like.

If the series of processes is implemented by software, a program constituting the software is installed into a computer incorporated in special-purpose hardware or a general-purpose personal computer capable of executing various functions by installing various programs from a network or a recording medium.

The recording medium may be a packaged medium separate from the apparatus for providing the program to a user, such as, as shown in FIG. 3, the magnetic disk 41 (including a floppy disk), the optical disk 42 (including a CD-ROM (Compact Disk-Read Only Memory) and a DVD (Digital Versatile Disk)), the magneto-optical disk 43 (including an MD (Mini-Disk)), or the semiconductor memory 44, in which the program is recorded, or a device offered to a user as built-in form in the apparatus, such as the ROM 22 having the program, or a hard disk included in the storage unit 28.

In this document, the term system means the overall apparatus constituted by a plurality of devices.

1. An information processing system that communicates data between a communication terminal for obtaining a license including usage conditions of content, and a server connected to the communication terminal via a network,
wherein the communication terminal comprises:
transmitting means for transmitting first data including information about a first usage condition of the content and second data including information about a second usage condition of the content to the server; and
receiving means for receiving the data from the server,
the server comprises:
receiving means for receiving the first and second data;
data generating means for generating third data including information about a third usage condition of the content based on the first and second data; and
transmitting means for transmitting the third data to the communication terminal, and
the communication terminal transmits the first and second data to the server, and receives the third data from the server.

2. The system according to claim 1, wherein the first data includes condition information that includes the first usage condition, and the second data includes condition information that includes the second usage condition, and
the data generating means of the server generates the third data including condition information that includes the third usage condition obtained by combining the first usage condition with the second usage condition.

3. The system according to claim 1, wherein the data generating means of the server generates the third data, which is signed with a private key owned only by the server.

4. The system according to claim 1, wherein the first data, the second data, and the third data include information specifying at least the number of uses of the content or the usage period of the content.

5. The system according to claim 1, wherein the first data, the second data, and the third data include content identification information identifying the content.

6. The system according to claim 1, wherein the first data includes existing license information that is obtained by a user who is to use the content, and
the second data is additional difference information used to add a new usage condition to the first usage condition.

7. An information processing method for an information processing system that communicates data between a communication terminal for obtaining a license including usage conditions of content and a server connected to the communication terminal via a network, the method comprising:
a data transmitting step of transmitting first data and second data from the communication terminal to the server, the first data including information about a first usage condition of the content, the second data including information about a second usage condition of the content;
a data generating step of generating third data based on the first and second data when the server receives the first and second data, the third data including information about a third usage condition of the content; and
a data receiving step of receiving the third data from the server to the communication terminal.

8. The method according to claim 7, wherein the first data includes condition information defining the first usage condition, and the second data includes condition information that includes the second usage condition, and
the data generating step generates the third data including condition information that includes the third usage condition that is obtained by combining the first usage condition with the second usage condition.

9. The method according to claim 7, wherein the data generating step generates the third data, which is signed with a private key owned only by the server.

10. The method according to claim 8, wherein the first data includes existing license information that is obtained by a user who is to use the content,
the second data is additional difference information used to add a new usage condition to the first usage condition,
the method further comprises an updating request step of transmitting an updating request for updating the existing license information from the communication terminal to the server, and
in response to the updating request, the data transmitting step transmits the existing license and the additional difference information that is generated from information about the usage condition transmitted from the server to the server.

11. An information processing apparatus that issues a license including usage conditions of content, comprising:
receiving means for receiving first data including information about a first usage condition of the content and second data including information about a second usage condition of the content from a communication terminal for obtaining the license;
data generating means for generating third data including information about a third usage condition of the content from the first and second data; and
a transmitting step of transmitting means for transmitting the third data to the communication terminal.

12. The apparatus according to claim 11, wherein the first data includes condition information that includes the first usage condition, and the second data include condition information that includes the second usage condition, and
the data generating means generates the third data including condition information that includes the third usage condition obtained by combining the first usage condition with the second usage condition.

13. The apparatus according to claim 11, wherein the data generating means generates the third data, which is signed with a private key owned only by the apparatus.

14. An information processing method for issuing a license defining usage conditions of content, comprising:
a receiving step of receiving first data and second data from a communication terminal for obtaining the license, the first data including information about a first usage condition of the content, the second data including information about a second usage condition of the content;
a data generating step of generating third data from the first and second data, the third data including information about a third usage condition of the content; and
transmitting the third data to the communication terminal.
